(19) United States
(12) Patent Application Publication
(10) Pub. No.: US 2011/0227907 A1
(43) Pub. Date: Sep. 22, 2011

(54) HEAD-MOUNTED DISPLAY

(75) Inventor: Tomohiro SATO, Nagoya-shi (JP)

(73) Assignee: BROTHER KOGYO KABUSHIKI KAISHA, Nagoya-shi (JP)

(21) Appl. No.: 13/150,792

(22) Filed: Jun. 1, 2011

Related U.S. Application Data
(63) Continuation-in-part of application No. PCT/JP2009/006589, filed on Dec. 3, 2009.

(30) Foreign Application Priority Data
Dec. 10, 2008 (JP) 2008-313795

(51) Int. Cl. G06F 3/038

(52) U.S. Cl. 345/212

(57) ABSTRACT

A head-mounted display is provided. The head-mounted display includes an image presentation unit configured to present an image to an eye of a user, a control unit configured to play content data and control the image presentation unit to present an image obtained by playing the content data, a power supply management unit configured to manage supply and cutoff of power to the image presentation unit, and a detection unit configured to detect a segmentation point of content indicated by the content data played by the control unit. The control unit is configured to stop playing the content data in response to the detection unit detecting the segmentation point. The power supply management unit is configured to cut off the power supplied to the image presentation unit in response to the detection unit detecting the segmentation point.

### TECHNICAL FIELD

Aspects of the disclosure relate to a head-mounted display which can visually present a content image indicated by content data to a user so that the user can recognize the content image.

### BACKGROUND

A technique related to a head-mounted display has been proposed which can visually present a content image based on content data to a user so that the user can recognize the content image. For example, it has been proposed a technique to manage the supply of power to a head-mounted display to prevent a user from forgetting to turn off the head-mounted display, and particularly, a technique to automatically turn off the head-mounted display and an image presentation device which presents a content image for the head-mounted display, after a predetermined time period from the user taking off the head-mounted display.

### SUMMARY

A head-mounted display is expected to be used in, for example, various product manufacturing places. Specifically, for example, in a situation where an operator assembles a product, it is expected to present various operation instructions to the operator by the head-mounted display. In this example, even when the presentation of an image of operation instructions is stopped, the operator may continue to work with the head-mounted display on his head. Then, for starting subsequent operation, an image related to instructions for subsequent operation will be presented through his head-mounted display. While the presentation of an image is stopped, only an image transmission process is stopped (i.e., the head-mounted display continues to display a blank image thereon), and the power is kept being supplied to each component of the head-mounted display.

Accordingly, it is an aspect of the disclosure to provide a head-mounted display which can appropriately manage the supply of power thereto, and particularly, a head-mounted display capable of reducing power consumption.

Another aspect of the disclosure provides a head-mounted display which while a content image obtained by playing contend data is presented by an image presentation unit, detects a segmentation point in the content of the played content data, and when a segmentation point is detected, stops playing the content data and cuts off power supplied to the image presentation unit.

According to this configuration, it may be possible to provide a head-mounted display capable of appropriately managing power supply with a novel method, and particularly, a head-mounted display capable of reducing power consumption.

According to an illustrative embodiment of the disclosure, there is provided a head-mounted display including an image presentation unit, a control unit, a power supply management unit, and a detection unit. The image presentation unit is configured to present an image to an eye of a user. The control unit is configured to play content data and control the image presentation unit to present an image obtained by playing the content data. The power supply management unit is configured to manage supply and cutoff of power to the image presentation unit. The detection unit is configured to detect a segmentation point of content indicated by the content data played by the control unit. The control unit is configured to stop playing the content data in response to the detection unit detecting the segmentation point. The power supply management unit is configured to cut off the power supplied to the image presentation unit in response to the detection unit detecting the segmentation point.

According to another illustrative embodiment of the disclosure, there is provided a power supply management method for a head-mounted display. The method includes: detecting a segmentation point of content indicated by content data played by an image presentation unit configured to visually present an image to an eye of a user; in response to detecting the segmentation point in the detecting step, stopping the playing of the content data; and in response to detecting the segmentation in the detecting step, cutting off power supplied to the image presentation unit.

### BRIEF DESCRIPTION OF THE DRAWINGS

The above and other aspects of the disclosure will become more apparent and more readily appreciated from the following description of illustrative embodiments of the disclosure taken in conjunction with the attached drawings, in which:

FIGS. 1A, 1B, and 1C are diagrams illustrating the exterior of the main body of a head-mounted display according to an illustrative embodiment;

FIG. 2 is a diagram illustrating the head-mounted display when put on a user;

FIG. 3 is a diagram illustrating the configuration of the main body of the head-mounted display;

FIG. 4 is a block diagram illustrating a functional block of a control box of the head-mounted display;

FIG. 5 is a flowchart illustrating a first process executed by the control box;

FIG. 6 is a time chart related to an outline of content data and playing of the content data;

FIG. 7 is a flowchart illustrating a second process executed by the control box;

FIG. 8 is a segmentation table for use in the second process shown in FIG. 7;

FIGS. 9A, 9B and 9C are segmentation tables for use in a third process executed by the control box; and

FIG. 10 is a flowchart illustrating the third process executed by the control box.

### DETAILED DESCRIPTION

Illustrative embodiments of the disclosure will be described in the following. It is noted that embodiments of the disclosure are not limited to the specific configuration in the following, so that various changes, modifications can be applied within a technical concept of the disclosure. For example, the following description is provided taking, as an example, a head-mounted display including a head-mounted display main body and a control box connected to the head-mounted display main body and configured to provide a content image obtained by playing content data to the head-mounted display main body. However, the head-mounted display may be configured such that the head-mounted display main body and the control box are structured as one body. Hereinafter, the head-mounted display main body may be referred to simply as an HMD.

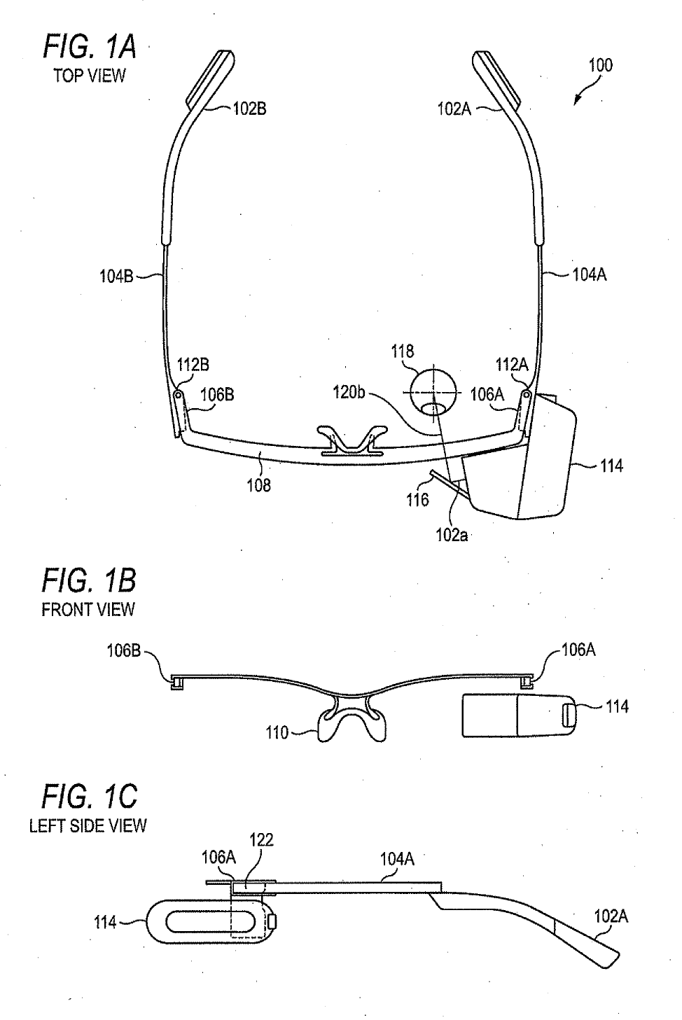

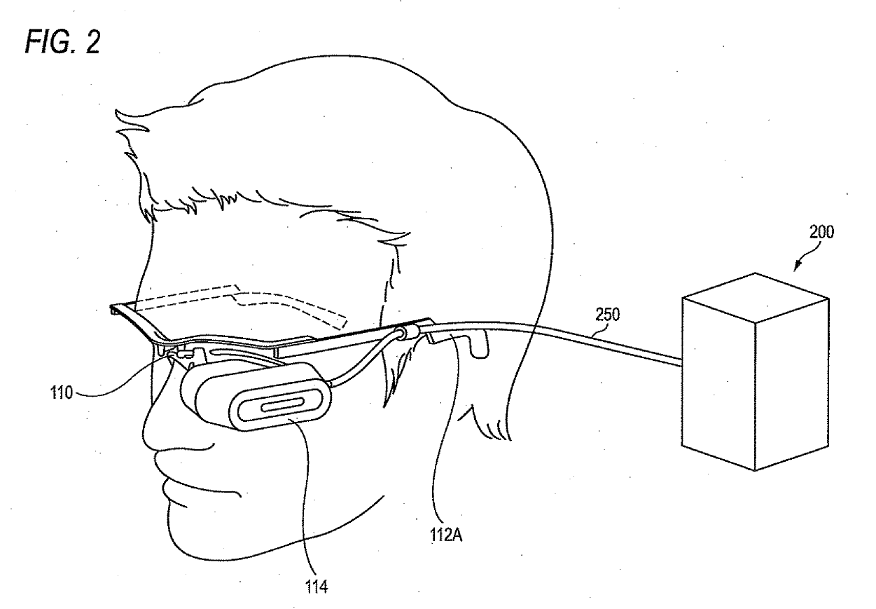

Referring to FIGS. 1A, 1B, and 1C, an HMD 100 includes temples 104a and 104b, end pieces 106A and 106B, and a front frame 108. Ends of temples 104a and 104b are respectively attached with temple covers 102A and 102B to contact the ears of a user. The other ends of the temples 104a and 104b are respectively provided with hinges 112A and 112B. The temples 104A and 104B are connected to the end pieces 106A and 106B by the hinges 112A and 112B, respectively. The front frame 108 connects the end pieces 106A and 10613. A nose pad 110 that is to be placed in contact with the nose of the user is attached to the center of the front frame 108. The framework of the HMD 100 is configured by the temples 104A and 104B, the end pieces 106A and 106B, the front frame 108, and the nose pad 110. Due to the hinges 112A and 112B that are provided to the end pieces 106A and 106B, the temples 104A and 104B can be folded. That is, the HMD 100 has almost the same structure as, for example, a typical eye glasses. Referring to FIG. 2, when the HMD 100 is put on the face of a user, the HMD 100 is supported by the end covers 102A and 102B and the nose pad 110. It is noted that the end covers 102A and 102E and the temples 104A and 104E are not illustrated in FIG. 1B.

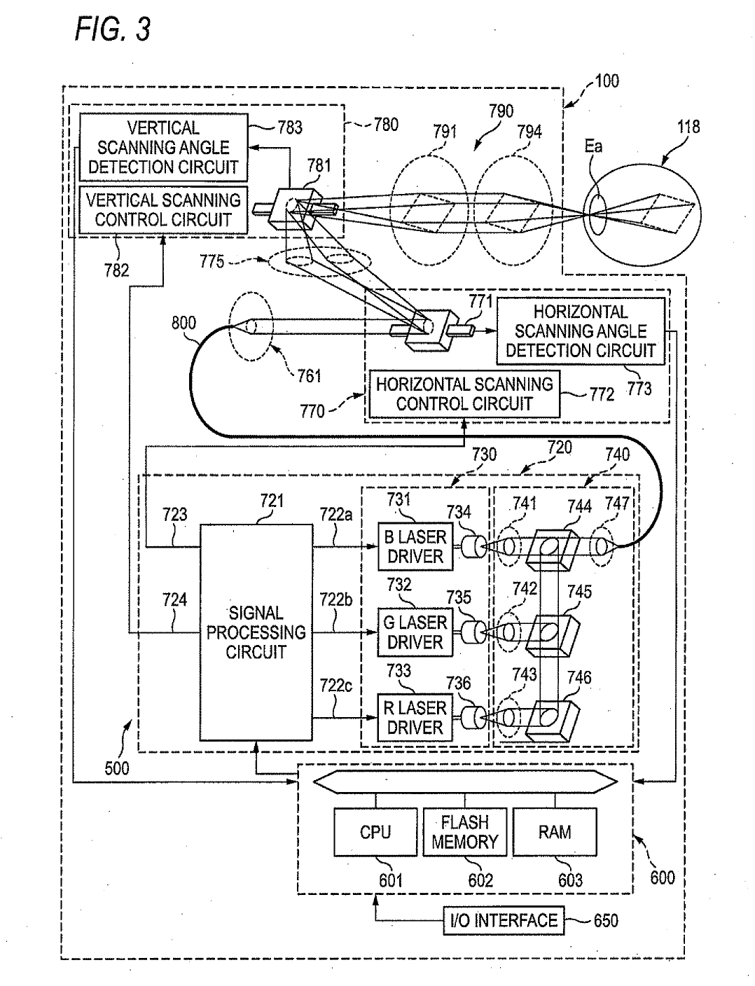

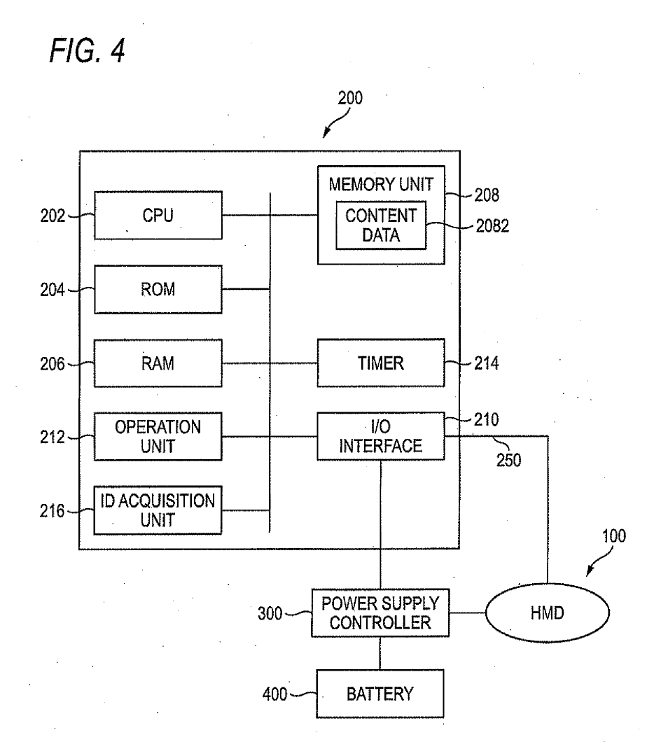

An image presentation device 114 is attached to the framework of the HMD 100 by an attachment unit 122 that is provided near the end piece 106A. When attached to the HMD 100 by the attachment unit 122, the image presentation device 114 is placed on a same level with a left eye 118 of a user wearing the HMD 100. Referring to FIG. 2, the image presentation device 114 is connected to a control box 200 via a signal cable 250. The control box 200 performs rendering process (playing process) on content data that is stored in a predetermined area, which will be described later in further detail. Referring to FIG. 4, the control box 200 includes an input/output (I/O) interface 210. By controlling the I/O interface 210, the control box 200 outputs a content image signal including a content image that is obtained by the rendering process, to the image presentation device 114 via the signal cable 250. Referring to FIG. 3, the image presentation device 114 includes an I/O interface 650. The image presentation device 114 receives the content image signal output by the control box 200 via the I/O interface 650, and optically emits a content image based on the received content image signal to a half mirror 116.

The content image, i.e., an image beam 120a, 120b is reflected by the half mirror 116. The reflected content image is incident upon the left eye 118. That is, the content image is presented to or projected onto the left eye 118 so that it can be viewed by the user. Accordingly, the user can recognize the content image. Referring to FIG. 1A, reference numeral 120a indicates an image beam corresponding to the content image, and reference numeral 120b indicates an image beam that is reflected from the half mirror 116 and incident upon the left eye 118. It is noted that the image presentation device 114 may be implemented as a liquid crystal display (LCD), an organic electroluminescence (EL) display, or the like, as well as a retina imaging display which scans the image beams 120a and 120b corresponding to the content image two-dimensionally, and directs the scanned image beams toward the left eye 118 to form a content image on the retina of the left eye 118. The HMD 100 is supplied with power from a battery 400 through a power supply controller 300 that is connected to the battery 400.

Referring to FIG. 3, the HMD 100 includes a control unit 600. The control unit 600 includes a central processing unit (CPU) 601 which controls the HMD 100, a flash memory 602 which is a nonvolatile memory and stores various programs, and a random access memory (RAM) 603 which is used as a working area. The CPU 601 receives various signals from the control box 200, and executes the programs stored in the flash memory 602 in the RAM 603 using the received signals to function as various units. The HMD 100 also includes an optical scanning unit 500. The optical scanning unit 500 two-dimensionally scans image beams that are generated based on an image signal provided by the control unit 600, i.e., the image beams 120 and 120b illustrated in FIG. 1A, and directs the scanned image beams toward the left eye 118, thereby forming a content image on the retina of the left eye 118.

The optical scanning unit 500 includes an image beam generator 720. The image beam generator 720 reads the image signal provided by the control unit 600 on a dot clock basis, generates an intensity-modulated image beam based on the read image signal, and emits the generated image beam. A collimate optical system 761, a horizontal scanner 770, a vertical scanner 780, a relay optical system 775, and a relay optical system 790 are provided between the image beam generator 720 and the left eye 118. The collimate optical system 761 transforms a laser beam emitted from the image beam generator 720 through an optical fiber 800 into a parallel beam. The horizontal scanner 770 serves as a first optical scanner that scans the parallel beam provided by the collimate optical system 761 reciprocally in a first direction, e.g., a horizontal direction, to display an image. The vertical scanner 780 serves as a second optical scanner that scans an image beam scanned horizontally by the horizontal scanner 770 reciprocally in a second direction substantially perpendicular to the first direction, e.g., a vertical direction. The relay optical system 775 is provided between the horizontal and vertical scanners 770 and 780. The relay optical system 790 emits image beams that are scanned in the horizontal and vertical directions, i.e., image beams that are scanned two-dimensionally, toward a pupil Ea of the left eye 118.

The image beam generator 720 includes a signal processing circuit 721. The signal processing circuit 721 receives a content image signal from the control box 200 via the I/O interface 650 and the control unit 600. The signal processing circuit 721 generates various signals for synthesizing a content image based on the content image signal. For example, the signal processing circuit 721 generates and outputs blue (B), green (G), and red (R) image signals 722a, 722b, and 722c. The signal processing circuit 721 also outputs a horizontal driving signal 723 for use in the horizontal scanner 770 and a vertical driving signal 724 for use in the vertical scanner 780.

The image beam generator 720 includes a light source unit 730 and an optical synthesis unit 740. The light source unit 730 serves as an image beam output unit which emits the R, G, and B image signals 722a, 722b, and 722c output at every dot clock by the signal processing circuit 721 as image beams. The optical synthesis unit 740 synthesizes the three image beams output by the light source unit 730 into a single image beam to generate image light.

The light source unit 730 includes a B laser 734 which generates blue image light, a B laser driver 731 which drives the B laser 734, a G laser 735 which generates green image light, a G laser driver 732 which drives the G driver 735, an R laser 736 which generates red image light, and an R laser driver 733 which drives the R laser 736. For example, the B, G, and R lasers 734, 735, and 736 may be implemented as semiconductor lasers or solid lasers equipped with a harmonic wave generator. When employing semiconductor lasers as the B, G, and R lasers 734, 735, and 736, the intensity of image light can be modulated by directly modulating a driving current. When employing the solid lasers as the B, G, and R lasers 734, 735, and 736, it is necessary to provide an external modulator for each of the lasers to modulate the intensity of image light.

The optical synthesis unit 740 includes collimate optical systems 741, 742, and 743, dichroic mirrors 744, 745, and 746, and a combining optical system 747. The collimate optical systems 741, 742, and 743 respectively collimate image beams incident thereupon from the light source unit 730, thereby obtaining parallel beams. The dichroic mirrors 744, 745, and 746 respectively synthesize the parallel beams provided by the collimate optical systems 741, 742, and 743. The combining optical system 747 directs a synthesized image beam obtained by synthesizing the parallel beams provided by the collimate optical systems 741, 742, and 743 into the optical fiber 800.

Laser beams emitted from the B, G, and R lasers 734, 735, and 736 are collimated by the collimate optical systems 741, 742, and 743, and incident upon the dichroic mirrors 744, 745, and 746. The laser beams incident upon the dichroic mirrors 744, 745, and 746 are selectively reflected by or transmit through the dichroic mirrors 744, 745, and 746 according to their wavelength.

Specifically, a B image beam emitted from the B laser 734 is collimated by the collimate optical system 741, and the collimated B image beam is incident upon the dichroic mirror 744. A G image beam emitted from the G laser 735 is incident upon the dichroic mirror 745 through the collimate optical system 742. An R image beam emitted from the R laser 736 is incident upon the dichroic mirror 746 through the collimate optical system 743.

The three primary-color image beams respectively incident upon the dichroic mirrors 744, 745, and 746 reach the combining optical system 747 by being reflected by or transmitting through the dichroic mirrors 744, 745, and 746, are combined by the combining optical system 747, and then output to the optical fiber 800.

The horizontal and vertical scanners 770 and 780 scan an image beam incident thereupon from the optical fiber 800 in the horizontal and vertical directions, respectively, such that the incident image beam can become projectable as an image.

The horizontal scanner 770 includes a resonant-type deflector 771, a horizontal scanning control circuit 772, and a horizontal scanning angle detection circuit 773. The resonant-type deflector 771 has a reflective surface for scanning an image beam in the horizontal direction. The horizontal scanning control circuit 772 serves as a driving signal generator which generates a driving signal for resonating the resonant-type deflector 771 to vibrate the reflective surface of the resonant-type deflector 771. The horizontal scanning angle detection circuit 773 detects a state of the vibration of the resonant-type deflector 771, such as the degree and frequency of the vibration of the reflective surface of the resonant-type deflector 771, based on a displacement signal output from the resonant-type deflector 771.

In this illustrative embodiment, the horizontal scanning angle detection circuit 773 outputs a signal indicating the state of the vibration of the resonant deflector 771 to the control unit 600.

The vertical scanner 780 includes a deflector 781, a vertical scanning control circuit 782, and a vertical scanning angle detection circuit 783. The deflector 781 scans an image beam in the vertical direction. The vertical scanning control circuit 782 drives the deflector 781. The vertical scanning angle detection circuit 783 detects a state of the vibration of the deflector 781, such as the degree and frequency of the vibration of the reflective surface of the deflector 781.

The horizontal scanning control circuit 772 is driven by the horizontal driving signal 723 that is output from the signal processing circuit 721, and the vertical scanning control circuit 782 is driven by the vertical driving signal 724 that is output from the signal processing circuit 721. The vertical scanning angle detection circuit 783 outputs a signal indicating the state of the vibration of the deflector 781 to the control unit 600.

The control unit 600 adjusts the horizontal and vertical driving signals 723 and 724 by controlling the operation of the signal processing circuit 721. By adjusting the horizontal and vertical driving signals 723 and 724, the control unit 600 can vary the scanning angles of the horizontal and vertical scanners 770 and 780 and thus adjust the brightness of an image to be displayed.

The control unit 600 detects variations in the scanning angles of the horizontal and vertical scanners 770 and 780 based on detection signals provided by the horizontal and vertical scanning angle detection circuits 773 and 783. The results of the detection of the variations in the scanning angles of the horizontal and vertical scanners 770 and 780 are fed back to the horizontal driving signal 723 through the signal processing circuit 721 and the horizontal scanning control circuit 772, and are also fed back to the vertical driving signal 724 through the signal processing unit 721 and the vertical scanning control circuit 782.

The relay optical system 775 relays image light between the horizontal and vertical scanners 770 and 780. For example, an image beam scanned horizontally by the resonant deflector 771 is converged on the reflective surface of the deflector 781 by the relay optical system 775. The image beam converged on the reflective surface of the deflector 781 is scanned vertically by the deflector 781, and is emitted toward the relay optical system 790 as a two-dimensionally scanned image beam.

The relay optical system 790 includes lens systems 791 and 794 having a positive refractive power. The scanned image beams emitted from the vertical scanner 780 are collimated by the lens system 791 such that the center lines of the scanned image beams are parallel to each other, and converted into converged image beams. The converged image beams become substantially parallel by the lens system 794, and converted such that the center lines of the image beams converged on the pupil Ea.

It is noted that in this illustrative embodiment, light emitted from the optical fiber 800 scanned horizontally by the horizontal scanner 770 and then scanned vertically by the vertical scanner 780. However, the order of scan may be opposite. That is, the light emitted from the optical fiber 800 may be scanned vertically by the vertical scanner 780 and then scanned horizontally by the horizontal scanner 770.

(Configuration of Control Box)

The control box 200 is attached to, for example, the waist of the user. Referring to FIG. 4, the control box 200 includes a CPU 202 which controls the operation of the control box 200, a ROM 204 which stores various programs, a RAM 205 which is used as a working area, a memory unit 208 which stores content data 2082, a power supply controller 300 which supplies and cuts off power to the HMD 100 and the control box 200, the I/O interface 210 via which various signals are transmitted or received, an operation unit 212 which is operated by the user and receives instructions from the user, a timer 214 which measures time, and an identification (ID) acquisition unit 216 which acquires ID information corresponding to a user from an integrated circuit (IC) card or the like held by the user.

The memory unit 208 is configured by a hard disc, for example. The content data 2082 stored in the memory unit 208 indicates the content of a manual for the assembly of a product, for example. The operation unit 212 includes one or more keys, and receives instructions to start and end the playing of the content data 2082. For example, the ID acquisition unit 216 is configured by a radio-frequency identification (RFID) reader which reads information from an RFID tag embedded in an IC card using an electromagnetic induction or radio waves. Alternatively, the ID acquisition unit 216 may be configured to read ID information by directly contacting with an IC card, or configured to read ID information from a magnetic stripe card by using a magnetic head.

The CPU 202 acquires a content image by executing a program in the ROM 204 for playing (or rendering) the content data 2082 in the RAM 206. The CPU 202 outputs a content image signal including the content image to the HMD 100 via the I/O interface 210 by executing a program in the ROM 204 for controlling the I/O interface 210 in the RAM 206. The CPU 202 causes the power supply controller 300 to manage the supply and cutoff of power to the HMD 100 by executing, in the RAM 206, a program in the ROM 204 for controlling the power supply controller 300 based on segmentation information related to a segmentation point of the played content. Further, the CPU 202 controls the operation of the HMD 100 based on instructions input through the operation unit 212 and the operation of the HMD 100 based on the segmentation information, by executing a program in the ROM 204 for controlling the HMD 100 in the RAM 206. Accordingly, by the CPU 202 executing, in the RAM 206, the programs in the ROM 204 using various data, such as the content data 2082 and the like, various function units, e.g., a control unit, a power supply management unit, and a detection unit, are realized.

(Process Executed by the Control Box)

In the following, each of three processes which are performed by the CPU 202 executing the programs in the ROM 204 will be further described.

(First Process)

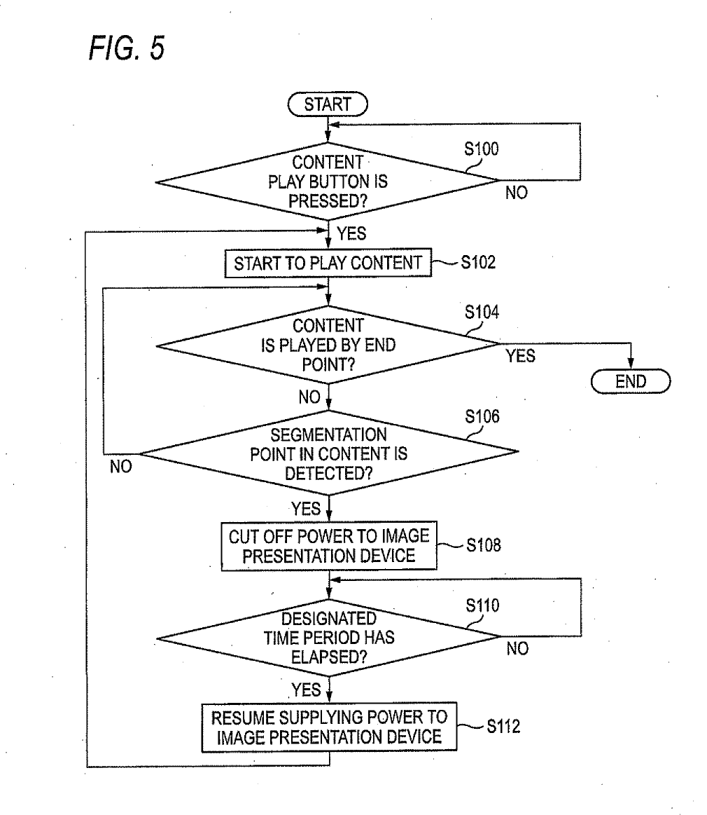

A first process is executed when the content data itself includes segmentation information indicating a segmentation point in the content indicated by the content data 2082. In the first process shown in FIG. 5, the content data 2082 is assumed to be moving image data which includes, as header information, the segmentation information indicating a segmentation point of the content.

Referring to FIG. 5, firstly, the CPU 202 determine whether an instruction to play content stored in the memory unit 208, e.g., the content data 2082, is input via the operation unit 212 (S100). Based on the determination, if the instruction to play the content data 2082 is not input (S100: No), the CPU 202 waits until an instruction to play the content data 2082 is input via the operation unit 212. On the other hand, if an instruction to play the content data 2082 is input via the operation unit 212 (S100: Yes), the CPU 202 reads out the content data 2082 from the memory unit 208 into the RAM 206 and starts to play the content data 2082 (S102). Specifically, the CPU 202 renders the content data 2082, generates a content image, and outputs a content image signal including the content image to the HMD 100 via the I/O interface 210.

The image presentation device 114 of the HMD 100 receives the content image signal from the control box 200 via the I/O interface 650 illustrated in FIG. 3, and optically emits a content image based on the received content image signal toward the half mirror 116. The content image (or image light) emitted from the image presentation device 114 is reflected by the half mirror 116, and thus be incident upon the left eye 118, as illustrated in FIG. 1A. That is, the content image reflected from the half mirror 116 is presented or projected to the user so that it can be viewed by the user. Accordingly, the user can recognize the content image emitted from the image presentation device 114.

The CPU 202 determines whether the playing of the content data 2082 is completed, that is, whether the content data 2082 has been played to an end point thereof (S104). If the content data 2082 has been played to the end point (S104: Yes), the CPU 202 cuts off the power to the HMD 100 by reading out a program for controlling the power supply controller 300 from the ROM 204 and executing the program in the RAM 206. Then, this process ends. On the other hand, if the content data 2082 has been not yet played to the end point (S104: No), the CPU 202 causes this process to proceed to S106.

At S106, the CPU 202 determines whether a segmentation point in the content indicated by the content data 2082 is detected based on the segmentation information that is included in the content data 2082 as header information. Specifically, the CPU 202 determines whether the content data 2082 has been played to a segmentation point defined by the segmentation information. If any segmentation point is not detected (S106: No), the CPU 202 causes the process to return to S104, and continues to play the content data 2082. On the other hand, if a segmentation point is detected (S106: Yes), the CPU 202 causes the process to proceed to S108.

At S108, the CPU 202 reads out, into the RAM 206, a program in the ROM 204 for controlling the power supply controller 300, and executes the program in the RAM 206 (S108). Based on the program, the CPU 202 cuts off the power supplied by the power supply controller 300 to the HMD 100, and more particularly, the power supplied by the power supply controller 300 to the image presentation device 114. When cutting off the power supply, the CPU 202 stops playing the content data 2082, and stores a point where the playing of the content data 2082 is stopped, in the RAM 206. Here, the CPU 202 measures an elapsed time from the detection of the segmentation point in the content data 2082 by the timer 214.

Then, the CPU 202, which has measured the elapsed time by the timer 214, determines whether a time period that is designated by time information included in the content data 2082 has elapsed (S110). The time information is included in the content data 2028 while being associated with the segmentation point detected at S106, and indicates a time when to resume the playing of the content data 2082, more specifically, a time while the playing of the content data 2082 is stopped. In other words, the time information relates to a time period from a time when the power supply to the image presentation device 114 is cutoff to a time when the power supply is to be resumed. If the designated time period has not elapsed yet (S110: No), the CPU 202 waits until the designated time period elapses. On the other hand, if the designated time period has elapsed (S110: Yes), the CPU 202 executes a program in the ROM 204 for controlling the power supply controller 300 in the RAM 206, and controls the power supply controller 300 to resume the supply of power to the image presentation device 114 (S112). Then, the CPU 202 causes the process to return to S102, and resumes the playing of the content data 2082 from the point stored in the RAM 206 at S108, i.e., the point where the playing of the content data 2082 was stopped.

In the above illustrative embodiment, if a segmentation point in the content data 2082 is detected by the CPU 202 (S106: Yes), the CPU 202 cuts off the power to the image presentation device 114. However, alternatively, the CPU 202 may cut off the power to the whole HMD 100 if a segmentation point in the content data 2082 is detected by the CPU 202 (S106: Yes). That is, the power to components including the image presentation device 114 and the control box 200 may be cut off. Further, it may be determined whether to cut off the power to the image presentation device 114 or the power to the whole HMD 100 according to the remaining power of the battery 400. Specifically, in this case, the CPU 202 may cut off the power to only the image presentation device 114 if the remaining power of the battery 400 exceeds a reference level, and may cut off the power to the whole HMD 100 if the remaining power of the battery 400 does not exceeds the reference level. According to this configuration, it is possible to reduce a time required for the HMD 100 to resume its operation and possible to efficiently drive the HMD 100 for a long time.

In the following, an example will be described where the content data 2082 is 10-minute-long moving image data of a manual for assembling a product.

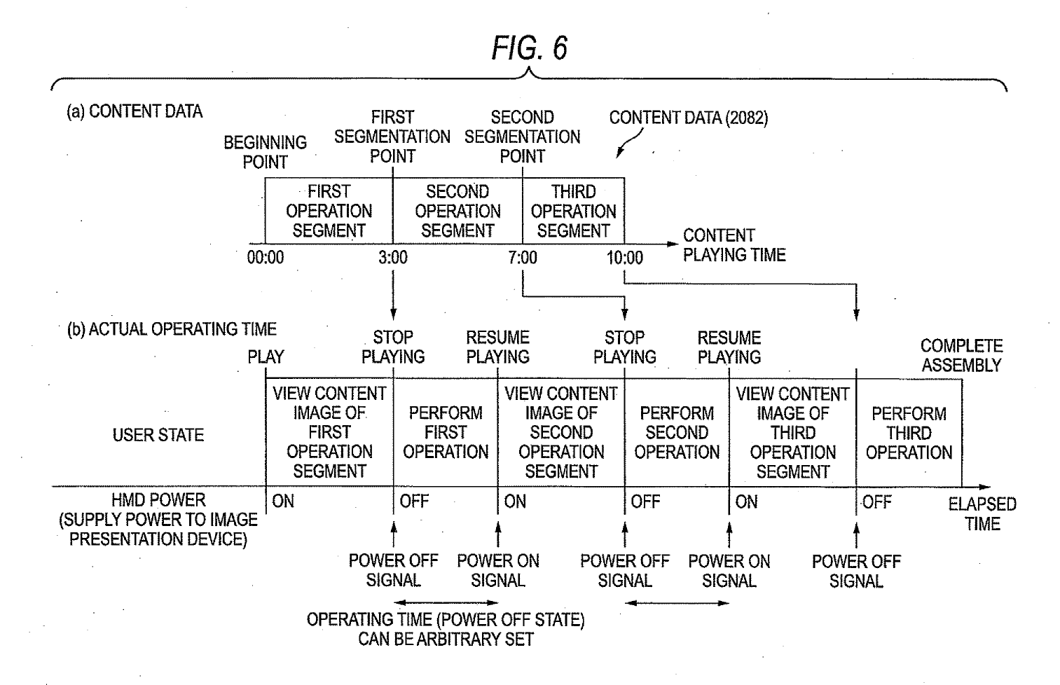

Referring to (a) of FIG. 6, the body of the content data 2082 is divided into a first operation segment (length: 3 minutes), a second operation segment (length: 4 minutes), and a third operation segment (length: 3 minutes). The content data 2082 includes first segmentation information inserted between the first and second operation segments as header information, and second segmentation information inserted between the second and third operation segments as header information. The content data 2082 further includes first time information (not shown) corresponding to the first segmentation information and second time information (not shown) corresponding to the second segmentation information as header information. Each of the first time information and the second time information designate the above-described time period. The designated time period (time information) may be set arbitrarily by the user.

Referring to (b) of FIG. 6, if it is instructed through the operation unit 212 of the control box 200 to play the content data 2082 (refer to S100: Yes of FIG. 5), the playing of the content data 2082 starts. With this start of the playing, a content image corresponding to the first operation segment is presented to the user by the image presentation device 114 illustrated in FIG. 1A. That is, a user starts viewing the content image corresponding to the first operation segment. Then, if the CPU 202 detects the first segmentation information that is set as header information (refer to S106: Yes of FIG. 5), the CPU 202 stops playing of the content data 2082, and controls the power supply controller 300 to cut off the power to the image presentation device 114 (refer to S108 of FIG. 5). The CPU 202 starts measuring the elapsed time in response to the detection of the first segmentation information by using the timer 214.

The user performs a first operation based on the content image corresponding to the first operation segment. A designated time period corresponding to the first time information is set in advance based on an amount of time required for the user to finish the first operation. The user performs a product assembly operation according to the first operation based on information obtained by viewing the content image, within the designated time period corresponding to the first time information. At this time, the user views the outside of the HMD 100 through the half mirror 116. Specifically, the user starts assembling a product while viewing component parts of the product also with the left eye 118 through the half mirror 116.

If the timer 214 measures that the designated time period corresponding to the first segmentation information has elapsed (refer to S110: Yes of FIG. 5), the CPU 202 again controls the power supply controller 300 to resume the supply of power to the image presentation device 114 (refer to S112 of FIG. 5), and starts playing the second operation segment (refer to S102 of FIG. 5). Accordingly, a content image corresponding to the second operation segment is presented to the user by the image presentation device 114. That is, the user starts viewing the content image corresponding to the second operation segment. Then, if the CPU 202 detects the second segmentation information set in the header information that is provided at 7 minutes after the beginning of the content data 2082 (refer to S106: Yes of FIG. 5), the CPU 202 stops playing the content data 2082 again, and controls the power supply controller 300 to cut off the power to the image presentation device 114 (refer to S108 of FIG. 5). Then, the CPU 202 measure the elapsed time in response to the detection of the second segmentation information by using the timer 214. The user performs a product assembly operation according to the second operation based on information obtained by viewing the content image for the second operation segment. It is noted that a designated time period corresponding to the second segmentation information is set in advance based on an amount of time required for the user to finish the second operation, similarly to the designated time period corresponding to the first segmentation information.

If the timer 214 measures that the designated timer period corresponding to the second segmentation information has elapsed (refer to S110: Yes of FIG. 5), the CPU 202 controls the power supply controller 300 to resume the supply of power to the image presentation device 114 (refer to S112 of FIG. 5), and starts playing the third operation segment (refer to S102 of FIG. 5). Accordingly, a content image corresponding to the third operation segment is presented to the user by the image presentation device 114. That is, the user starts viewing the content image corresponding to the third operation segment. Then, if the CPU 202 plays the content data 2082 to the end point thereof (refer to S104: Yes of FIG. 5), the CPU 202 stops playing the content data 2082, and controls the power supply controller 300 to cut off the power to the image presentation device 114. Then, the above-mentioned process of the CPU 202 ends. The user performs a product assembly operation according to the third operation based on information obtained by viewing the content image corresponding to the third operation segment, thereby completing the assembly of the product.

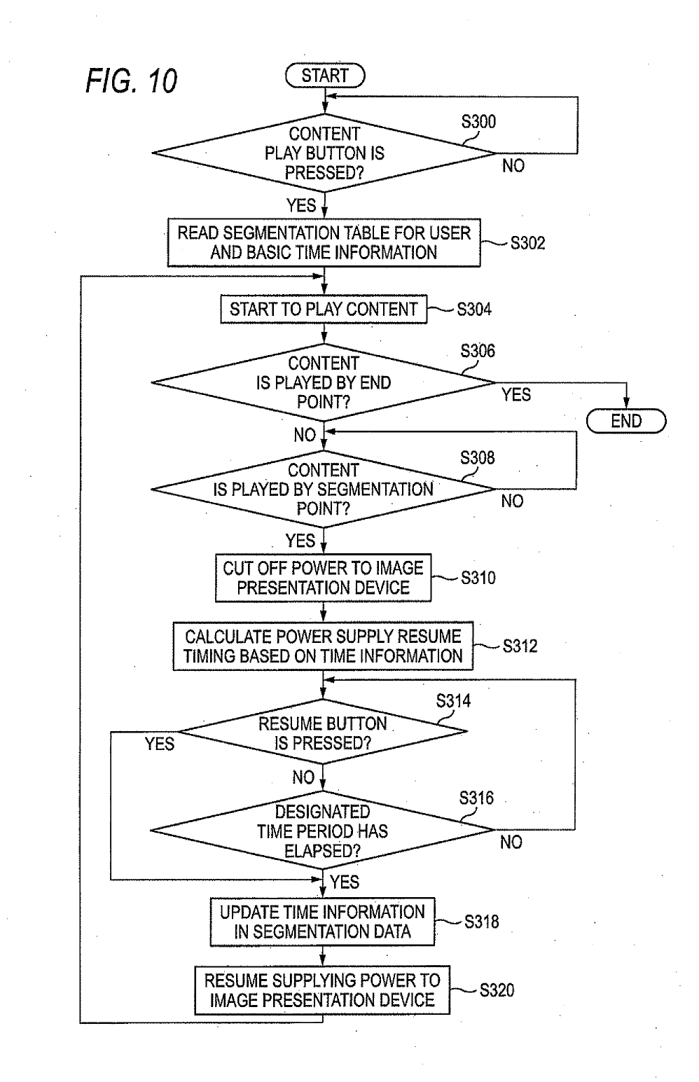

In the above, the CPU 202 resumes playing the content data 2082 after the elapse of designated time period. However, for example, the playing of the content data 2082 may be resumed by an instruction input to the CPU 202 via the operation unit 212 (refer to S314 of FIG. 10). This example may be suitable for a case where the user is well skilled in assembling the product and is expected to finish the assembly of the product within a very short time period.

(Advantageous Effects of First Process)

According to the first process, the following advantageous effects would be obtained.

(1) In the first process, a segmentation point of the content is detected based on segmentation information included in the content data 2082 as header information (refer to S106 of FIG. 5). If a segmentation point is detected (S106: Yes of FIG. 5), the CPU 202 stops playing process, and cuts off the power supplied from the battery 400 to the image presentation device 114 (S108 of FIG. 5). According to this configuration, it is possible to reduce the power consumption of the HMD 100 when no content image is presented to the user who is assembling a product while wearing the HMD 100 and to drive the HMD 100 for a long time with the battery 400. This configuration is particularly suitable for a case where content images are presented intermittently or not continuously to the user with the use of the battery 400. Additionally, since the power to the image presentation device 114 is cut off during assembly of a product, the user can properly view the outside of the HMD 100 through the half mirror 116 to obtain view in a similar degree to the case where the user does not wear the HMD 100. Further, since there is no need for the user to perform additional operations to cut off the power to the image presentation device 114, it is possible to reduce the burden on the user regarding the operation of the HMD 100.

(2) In the first process, supplying of the power to the image presentation device 114 is resumed after the preset designated time period from detection of a segmentation point in the content (S112 of FIG. 5), and playing of the content data 2082 is resumed from the point where the playing of the content data 2082 was stopped (S102 of FIG. 5). According to this configuration, it is possible to resume supplying power to the image presentation device 114 at an appropriate timing. Additionally, since there is no need for the user to perform additional operations to resume supplying power to the image presentation device 114, it is possible to reduce the burden on the user regarding the operation of the HMD 100.

(Second Process)

In the first process, the content data 2082 includes segmentation information indicating a segmentation point in the content and time information corresponding to the segmentation information as header information. In a second process, the segmentation information and the time information are included in a segmentation table which is different from the content data 2082. A content data body of the content data 2082, which configures the content data 2082 with header information, includes time stamp information. The time stamp information indicates a position (elapsed time) from the beginning of the content data body. During the playing of the content data 2082, the currently played position can be specified by the time stamp information. The second process is different from the first process in the above aspect but same as the first process except for that aspect. Thus, the second process will be described while focusing mainly on the differences from the first process, and details will be omitted. The segmentation table is stored in a region that can be accessed by the control box 200. In the following, the segmentation table is stored in the memory unit 208, for example.

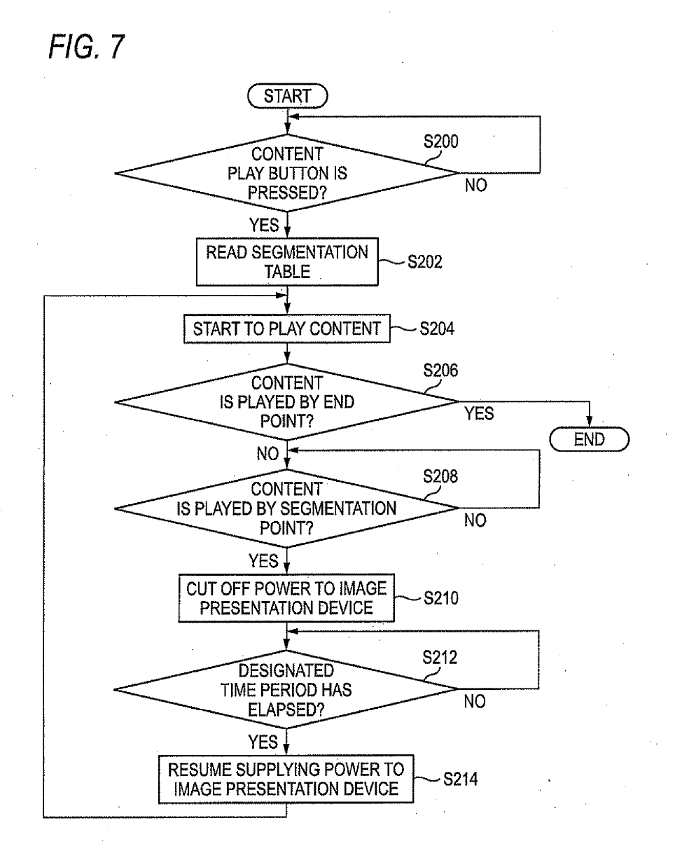

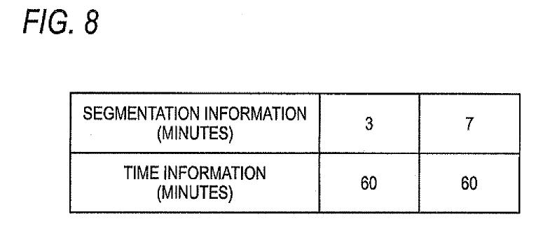

Referring to FIG. 7, firstly in the second process, the CPU 202 performs S200, which corresponds to S100 of FIG. 5. If an instruction to play the content data 2082 is input via the operation unit 212 (S200: Yes), the CPU 202 causes the process to proceed to S202. At S202, the CPU 202 reads out the segmentation table from the memory unit 208 into the RAM 206 (S202). Referring to FIG. 8, the segmentation table includes segmentation information indicating a segmentation point in the content data 2082 and time information while being associated with each other. For example, referring to FIGS. 6 and 8, the segmentation table includes first segmentation information (3 minutes) that indicates the segmentation point between the first operation segment and the second operation segment, and first time information (60 minutes) set as an operation time for the first operation while associated with the first segmentation information, and includes second segmentation information (7 minutes) that indicates the segmentation point between the second operation segment and the third operation segment, and second time information (60 minutes) set as an operation time for the second operation while being associated with the second segmentation information.

At S202, the CPU 202 reads out the first segmentation information, the first time information, the second segmentation information, and the second time information into the RAM 206, and performs S204 to S214. Herein, S204 to S214 correspond to S102 to S112 of FIG. 5, respectively. At S208, the CPU 202 determines whether the content data 2082 is played by a segmentation point in the content based on the first segmentation information and the second segmentation information and the time stamp information in the body of the content data 2082. For example, if the CPU 202 detects 3 minutes elapse corresponding to the first segmentation information based on the time stamp of the content data body of the content data 2082, the determination of S208 becomes positive (S208: Yes). Similarly, if the CPU 202 detects 7 minutes elapse corresponding to the second segmentation information based on the time stamp of the body of the content data 2082, the determination of S208 becomes positive (S208: Yes). The time chart of the second process would be same as that illustrated in (b) of FIG. 6 which is described in the first process, and thus, a detailed description will be omitted.

(Advantageous Effects of Second Process)

According to the second process, the following advantageous effects would be obtained in addition to that obtained in the first process.

(1) In the second process, the segmentation information and the time information is included in the segmentation table (FIG. 8) which is different data from the content data 2082, and the CPU 202 obtains the segmentation information and the time information from the segmentation table. Accordingly, it is possible to easily modify a time period (designated time period) to resume supplying power to the image presentation device 114 after the detection of a segmentation point in the content simply by editing the time information in the segmentation table without editing the content data 2082 itself.

(Third Process)

A third process is same as the second process in using a segmentation table. However, the third process is different from the second process in that a user who wears the HMD 100 is identified, time information is set differently depending on users and in the registering mode of time information in the segmentation table. Thus, the third process will be described while focusing mainly on the differences from the second process.

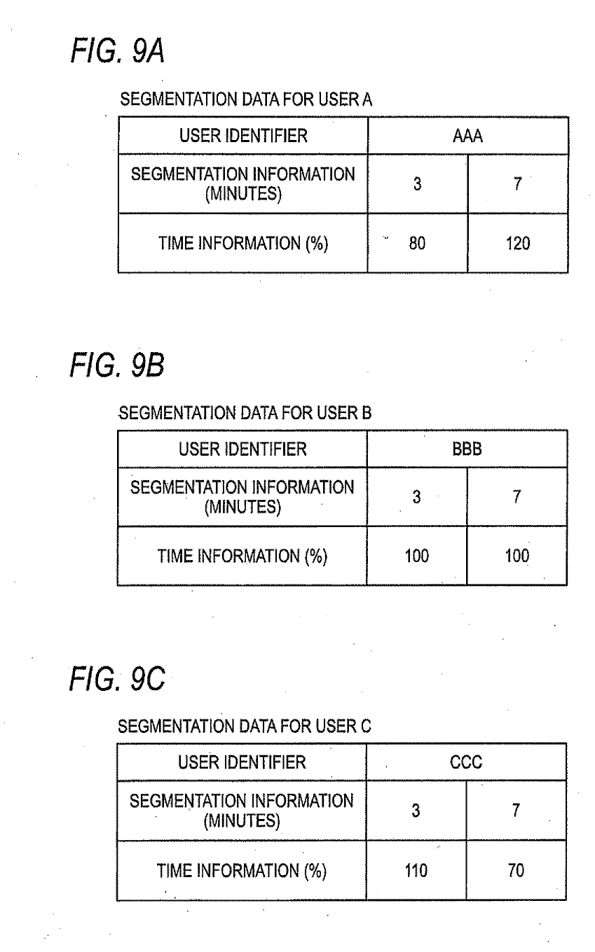

Firstly, examples of the segmentation table that can be used in the third process are described with reference to FIGS. 9A, 9B and 9C. In the third process, segmentation tables are stored in the memory unit 208 for respective users of the HMD 100. For example, referring to FIG. 9A, an identifier ‘AAA’ for identifying user A, first segmentation information, first time information corresponding to the first segmentation information, second segmentation information, and second time information corresponding to the second segmentation information are registered in a segmentation table for user A, while being associated with one another. Herein, the registering manner of time information in the third process is different from that of the second process. That is, in the third process, basic time information is stored in the memory unit 208 while being associated with the segmentation table, and a ratio with respect to the basic time information is stored as the time information in the segmentation table. For example, the memory unit 208 stores the first operation time period (60 minutes) and the second operation time period (60 minutes) as the basic time information, and ratios with respect to the first and second operation time periods are registered in the segmentation table as the first and second time information. Specifically, referring to FIG. 9A, the first time information of 80% is registered in the segmentation table while being associated with the first segmentation information. In this case, the CPU 202 controls the power supply controller 300 to resume supplying power to the image presentation device 114 at 48 minutes (80% of 60 minutes) after the detection of the first segmentation information. Further, the second time information of 120% is registered in the segmentation table while being associated with the second segmentation information. In this case, the CPU 202 controls the power supply controller 300 to resume supplying power to the image presentation device 114 at 72 minutes (120% of 60 minutes) after the detection of the second segmentation information. The registration of the first time information and the second time information is performed in the same manner as in the example illustrated in FIG. 8, and thus, a detailed description thereof will be omitted.

Similarly to user A, a segmentation table shown in FIG. 9B is stored in the memory unit 208 for user B, and a segmentation table shown in FIG. 9C is stored in the memory unit 208 for user C. The registration mode of in these segmentation tables is same as that in FIG. 9A, and thus, a detailed description thereof will be omitted.

The process flow of the third process executed by the CPU 202 will be described with reference to FIG. 10. Firstly, the CPU 202 determines whether an instruction to play content stored in the memory 208, e.g., the content data 2082, is input via the operation unit 212 of the control box 200 (S300). Based on the determination, if the instruction to play the content data 2082 is not input (S300: No), the CPU 202 waits until an instruction to play the content data 2082 is input via the operation unit 212. On the other hand, if an instruction to play the content data 2082 is input by a user via the operation unit 212 (S300: Yes), the CPU 202 causes the process to proceed to S302. Here, in addition to the instruction, the CPU 202 reads out identification information of a user from, for example, an IC card held by the user into the RAM 206 via the ID acquisition unit 216. It is noted that the identification information may be input to the CPU 202 via the operation unit 212. In a case where the user C instructs to play data, the CPU 202 acquires identification information ‘CCC’ of user C.

At S302, the CPU 202 reads out a segmentation table corresponding to the read out identification information and basic time information from the memory unit 208. For example, if the identification information ‘CCC’ is acquired at S300, the CPU 202 reads out the segmentation table shown in FIG. 9C from the memory unit 208. The CPU 202 acquires first segmentation information, first time information, second segmentation information, and second time information from the read out segmentation table into the RAM 206. Then, the CPU 202 causes the process to proceed to S312 after performing S304 to S310. The operations S304 to S310 respectively correspond to S204 to S210 of FIG. 7 or S102 to S108 of FIG. 5, and thus, detailed descriptions thereof will be omitted. It is noted that, the operation S308 is performed based on the segmentation table acquired at S302. For example, in the above-described case, the operation S308 is performed based on the first and second segmentation information registered in the segmentation table for user C and time stamp information in the content data 2082.

At S312, the CPU 202 calculates a timing to resume supplying power to the image presentation device 114. The specific calculation method is already described in the above with reference to FIG. 9, and thus, a detailed description thereof will be omitted. Then, the CPU 202 determines whether an instruction to resume playing the content data 2082 is input via the operation unit 212 of the control box 202 (S314). Here, this configuration of allowing a user to input the instruction to resume is suitable for the following point. That is, for example, referring to FIG. 9C, in a case where the user C performs the first operation based on the presentation of the content image related to the first operation segment, it is possible that user C finishes the first operation within 40 minutes or less after the first segmentation information is detected while the designated time period for the first operation which is designated by the first time information is 42 minutes (=60 minutes×70%). In this case, user C is allowed to input an instruction to resume playing the content data 2082 and thus to view the content image corresponding to the second operation segment. Accordingly, it is possible to improve the efficiency of the assembly of the product.

If an instruction to resume playing the content data 2082 is input (S314: Yes), the CPU 202 causes the process to proceed to S318. On the other hand, if an instruction to resume playing is not input (S314: No), the CPU 202 determines whether a time period calculated based on the basic time information and the first time information or the second time information at S312 has elapsed (S316). Here, operation S316 corresponds to S212 of FIG. 7 or S110 of FIG. 5, and thus, a detailed description thereof will be omitted. If it is determined the calculated time period has elapsed (S316: Yes), the CPU causes the process to proceed to S318.

At S318, the CPU 202 updates (or overwrite) the first or second time information with a ratio with respect to the time period indicated by the basic time information, which corresponds to an actual time period from a time when a segmentation information is detected to a time when it is determined to resume playing. Specifically, in a case where it is instructed to resume playing at S314 (S314: Yes), the CPU 202 updates time information with new time information which is a ratio of a time period from a time when a segmentation information is detected to a time when an instruction to resume playing is input, with respect to the time period indicated by the basic time information. For example, in a case where user C finishes a product assembly operation according to the first operation by 36 minutes and then inputs an instruction to resume playing at that time, the CPU 202 updates the first time information registered in the segmentation table for user C as 60%. It is noted that if the calculated time period has elapsed (S316: Yes), the CPU 202 updates time information with the same value as that currently registered as the time information or may not update or overwrite the time information.

After S318, the CPU 202 causes the process to proceed to S320. S320 corresponds to S214 of FIG. 7 or S112 of FIG. 5, and thus, a detailed description thereof will be omitted. The time chart of the third process would be same as that illustrated in (b) of FIG. 6 which is described in the first process, and thus, a detailed description will be omitted.

(Advantages Effects of Third Process)

According to the third process, the following advantageous effects would be obtained in addition to that obtained in the first and second processes.

(1) In the third process, the segmentation tables are respectively provided for a plurality of users of the HMD 100, and stored in the memory unit 208 together with basic time information. The CPU 202 acquires identification information of a current user at the time of input of an instruction to play the content (S300 of FIG. 10). The CPU 202 calculates and acquires a time period (S312 of FIG. 10) from the detection of the segmentation point of the content (S308: Yes of FIG. 10) to a time to resume supplying power to the image presentation device 114 based on the segmentation table for the user identified by the acquire identification information and the basic time information. According to this configuration, it is possible to set a time for the resuming the supply of power to the image presentation device 114 appropriately for each user. Additionally, in the above example, it is possible to determine the time to resume supplying power to the image presentation device 114 and the time to resume presenting a content image to a user according to how much the user is skilled in the product assembly operation.

(2) In the third process, an instruction to resume playing the content is allowed to be input within the designated time period, and the CPU 202 determines whether an instruction to resume playing is input via the operation unit 212 of the control box 200 (S314 of FIG. 10). If an instruction to resume playing is input (S314: Yes of FIG. 10), the CPU 202 registers time information corresponding to an elapsed time from the detection of the segmentation point in the content (S308: Yes of FIG. 10) to a time of inputting the instruction to resume playing, in the segmentation table as new time information (S318 of FIG. 10). According to this configuration, it is possible to set a time for resuming the supply of power to the image presentation device 114 appropriately for each user. Additionally, it is possible to easily update time information registered in a segmentation table corresponding to each user according to how much the user is skilled in the product assembly operation.

In the first, second, and third processes, measurement of the elapsed time which is a basis for determining when to resume supplying power to the image presentation device 114 is started in response to the detection of segmentation information. However, the measurement may be started in response to the stop of playing process on the content data 2082 or stop of supplying power to the image presentation device 114.

### Modified Illustrative Embodiment

In the first, second, and third process, the detection of a segmentation point in the content (for example, S106 in the first process) is performed based on the segmentation information included in the content data 2082 as header information or the segmentation information registered in a segmentation table and time stamp information included in the content data body of the content data 2082. However, the disclosure is not limited thereto. A modified illustrative embodiment of the detection of a segmentation point will be described with reference to FIG. 5 while taking the first process as an example.

Referring to FIG. 5, if a user inputs an instruction to play content data in the memory unit 208, that is, an instruction to perform playing processing on the content data 2082, via the operation unit 212 of the control box 200 (S100: Yes), the CPU 202 reads out the content data 2082 from the memory unit 208 into the RAM 206, and generates a content image by playing the content data 2082 (S102).

Herein, generation of a content image having a single color may be detected as a segmentation point. Specifically, in a case where a content image is expressed by R (red), G (green) and B (Blue), if a content image having a value “R=0, G=0 and B=225” is generated by rendering in the playing process, the determination of S106 may be made positive based on the generation of the content image (S106: Yes). Alternatively, a predetermined image is stored in the memory unit 208, and if a content image same as the predetermined image is generated by rendering in the playing process, the determination of S106 may be made positive based on the generation of the content image (S106: Yes). According to this configuration, it is not necessary to set segmentation information for the content data 2082.

What is claimed is:

1. A head-mounted display comprising:
an image presentation unit configured to present an image to an eye of a user;
a control unit configured to play content data and control the image presentation unit to present an image obtained by playing the content data;
a power supply management unit configured to manage supply and cutoff of power to the image presentation unit; and
a detection unit configured to detect a segmentation point of content indicated by the content data played by the control unit,
wherein the control unit is configured to stop playing the content data in response to the detection unit detecting the segmentation point, and
wherein the power supply management unit is configured to cut off the power supplied to the image presentation unit in response to the detection unit detecting the segmentation point.

2. The head-mounted display according to claim 1, further comprising:
a time measurement unit configured, when the detection unit detects the segmentation point, to measure an elapsed time from the detection of the segmentation point,
wherein the power supply management unit resumes supplying power to the image presentation unit when the time measurement unit measures that the elapsed time has reached a time period indicated by time information included in the content data, the time information relating to when to resume supplying power to the image presentation unit after power supplied to the image presentation unit is cut off, and
wherein when supplying of the power to the image presentation unit is resumed, the control unit resumes playing the content data from a point where the playing of the content data was stopped.

3. The head-mounted display according to claim 1, further comprising:
a time measurement unit configured, when the detection unit detects the segmentation point, to measure an elapsed time from the detection of the segmentation point; and
an ID acquisition unit configured to acquire an identifier for identifying a user,
wherein the power supply management unit acquires, from a table which includes an identifier of each user and time information relating to when to resume supplying power to the image presentation unit after power supplied to the image presentation unit is cut off, while being associated with each other, time information associated with the identifier acquired by the ID acquisition unit,
wherein the power supply management unit resumes supplying power to the image presentation unit when the time measurement unit measures that the elapsed time has reached a time period indicated by the acquired time information, and
wherein when supplying of the power to the image presentation unit is resumed, the control unit resumes playing the content data from a point where the playing of the content data was stopped.

4. The head-mounted display according to claim 1, further comprising:
an operation unit configured to receive an instruction input by an operation of a user; and
an instruction acquisition unit configured, in a state where the detection unit has detected the segmentation point, to acquire a predetermined instruction received by the operation unit,
wherein when the instruction acquisition unit acquires the predetermined instruction, the power supply management unit resumes supplying power to the image presentation unit; and
wherein when supplying of the power to the image presentation unit is resumed, the control unit resumes playing the content data from a point where the playing of the content data was stopped.

5. The head-mounted display according to claim 1, further comprising:
a time measurement unit configured, when the detection unit detects the segmentation point, to measure an elapsed time from the detection of the segmentation point;
an operation unit configured to receive an instruction input by an operation of a user;
an instruction acquisition unit configured, in a state where the detection unit has detected the segmentation point, to acquire a predetermined instruction received by the operation unit,
an ID acquisition unit configured to acquire an identifier for identifying a user,
a memory unit configured to store a table including an identifier of each user and time information relating to when to resume supplying power to the image presentation unit after power supplied to the image presentation unit is cut off, while being associated with each other; and
a registration unit configured, in a state where the identifier has been acquired by the ID acquisition unit, when the predetermined instruction is acquired by the instruction acquisition unit, to register an elapsed time measured by the time measurement unit at a timing of the instruction acquisition unit acquiring the predetermined instruction, in the table as the time information while being associated with the identifier acquired by the ID acquisition unit,
wherein the power supply management unit acquires, from the table, the time information associated with the identifier acquired by the ID acquisition unit,
wherein the power supply management unit resumes supplying power to the image presentation unit when the time measurement unit measures that the elapsed time has reached a time period indicated by the acquired time information or when the instruction acquisition unit acquires the predetermined instruction, and
wherein when supplying of the power to the image presentation unit is resumed, the control unit resumes playing the content data from a point where the playing of the content data was stopped.

6. The head-mounted display according to claim 1,
wherein the detection unit detects segmentation information included in the content data during the playing of the content data by the control unit, and detects the segmentation point based on the detection of the segmentation information.

7. The head-mounted display according to claim 1,
wherein the detection unit detects playing of predetermined data indicating a predetermined image included in the content data by the control unit, and detects the segmentation point based on the detection of playing of the predetermined data.

8. The head-mounted display according to claim 1,
wherein the detection unit reads, from segmentation data including segmentation information indicating the segmentation point, the segmentation information, and detects the segmentation point based on the read segmentation information.

9. The head-mounted display according to claim 1,
wherein the head-mounted display is a see-through type which allows a user to view an image of an outside of the head-mounted display by transmitting external light therethrough.

10. A power supply management method for a head-mounted display, the method comprising:
detecting a segmentation point of content indicated by content data played by an image presentation unit configured to visually present an image to an eye of a user;
in response to detecting the segmentation point in the detecting step, stopping the playing of the content data; and
in response to detecting the segmentation in the detecting step, cutting off power supplied to the image presentation unit.
